(19) United States
(12) Patent Application Publication
(10) Pub. No.: US 2014/0018024 A1
(43) Pub. Date: Jan. 16, 2014

(54) Sliding Method and Device for Tuning Radio Stations

(71) Applicant: Stephen CHEN, CHANGHUA (TW)

(72) Inventor: Stephen CHEN, CHANGHUA (TW)

(73) Assignee: E-LEAD ELECTRONIC CO., LTD., CHANGHUA (TW)

(21) Appl. No.: 13/549,393

(22) Filed: Jul. 13, 2012

(51) Int. Cl. H04B 1/18

(52) U.S. Cl. 455/170.1

(57) ABSTRACT

The invention relates to a sliding method and device for tuning radio stations and, more particularly, to the sliding method and device using the car audio touch panel for tuning radio stations and fine tuning frequency by the finger. The device includes a radio module, a CPU and a touch panel. The touch panel includes a touch operation area and a frequency display area. By the device consisted of the above components, a control method is provided to tune radio station and fine tune frequency by using the sliding directions of the finger.

### BACKGROUND OF THE INVENTION

1. Field of the Invention

The invention relates to a sliding method and device for tuning radio stations and, more particularly, to the sliding method and device using the car audio touch panel for tuning radio stations and fine tuning frequency by the finger, to thereby achieve the purpose of quickly tuning radio stations.

2. Brief Description of Related Art

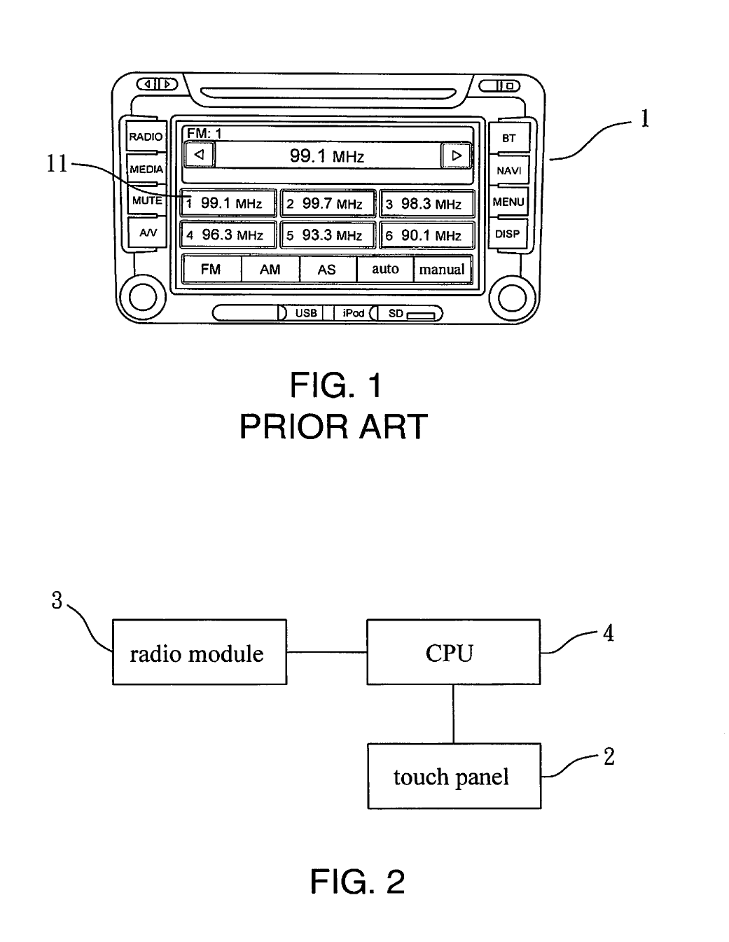

General car audio equipments have the AM/FM function. There are two ways to adjust frequency, one is searching for the last or the next frequency with programs, and another is fine tuning frequency for better signals, thus, different keys and knobs are used for controlling. As shown in FIG. 1, the user may choose channels of the radio module on the operation panel 1, such as AM, FM or directly click the set channel button 11, like button 1 99 MHZ. If there is no desired channel, a back button may be pressed for lowering frequency; otherwise, a forward button may be pressed for increasing frequency. If in the manual mode, the buttons should be pressed continuously; if in the automatic mode, the frequency may be stopped in the nearest channel after releasing the pressed buttons. In this way, except complicated operation, traffic safety may be affected especially when drivers seek different keys or switches on the road. Also, the frequency is difficult to be adjusted precisely.

In order to solve the drawbacks, the industry proposed various solutions. For example, the cited reference 1 with patent number TW 1354224 provides an interpreting architecture of multi-finger gesture applied to trigger an application program and an interpreting method thereof used in the same for interpreting a multi-finger gesture applied to a touch pad and then acquiring some hot-key information of at least an application program from a hot-key database in response to an interpreting result, so as to trigger said at least application program according to said some hot-key information, also, the corresponding operations may be performed for package programs.

As the cited reference 2 with publication number TW 201104529A1 provides a touch device using in the multi-touch operating environment, which generates sense signals for object sensing, and generates event signals according to the sense signals and control signals. The sense signals include the coordinate information of each touch point and cursor signals generated by the event signals. The cursor signals and the event signals may be sent to the multi-touch operating environment. The cursor signals are used to control the cursor application, the corresponding cursor of each touch point may be displayed on the screen and the cursor state may be changed. Each cursor represents a virtual finger of the user for conveniently knowing the corresponding location of each finger on the screen. By replacing actual fingers with the cursors, the touch events in the multi-touch operating environment may be executed. The purpose of multi-touch may be achieved even using the non-touch screen, just like operating on the multi-touch screen.

However, for the requirements of tuning radio station of the car audio, such complicated and strong operating functions are not needed. Also, the interpretation of finger sliding direction and motion should be simple and easy to operate during tuning radio stations and fine tuning frequency. Therefore, applying the technical means of the cited references 1 and 2 in tuning radio station operation of car audio may not correspond to the actual use requirements. Moreover, in the cited reference 1, the hotkey database for supporting various corresponding programs has to be constructed, it is not necessary for simple tuning radio station operation.

### SUMARRY OF THE INVENTION

In view of this, the inventor finally completed the present invention after numerous improvements. Namely, the object of the present invention is to provide a radio tuning method of operating the car audio touch panel by the finger, to thereby achieve the purpose of sliding the finger to tune radio stations and fine tune frequency.

And, another object of the present invention is to provide a radio tuning device of operating the car audio touch panel by the finger, to thereby achieve the purpose of sliding the finger to tune radio stations and fine tune frequency.

To achieve the object according to the invention, the sliding device for tuning radio stations of the present invention includes a radio module, a CPU and a touch panel, wherein:

the radio module, which receives radio waves, and decodes the received radio waves into sound signals;

the CPU, which is connected to the radio module and the touch panel, receives signals from the touch panel to adjust the radio module;

the touch panel, the screen of the touch panel includes a touch operation area and a frequency display area, the touch operation area is a functional area executing corresponding functions according to the touch position, and the frequency display area is a functional area generating corresponding station-tuning functions according to the sliding directions of the finger.

To achieve the object according to the invention, the sliding method based on the above device includes the following steps:

a. detecting that the finger touched the frequency display area, and generating corresponding station-tuning functions according to the sliding directions of the finger;

b. if a motion in a first direction is detected, searching the last station; if not, entering the next step;

c. if a motion in a second direction is detected, searching the next station; if not, entering the next step;

d. if a motion in a third direction is detected, increasing the frequency by a grid; if not, entering the next step;

e. if a motion in a fourth direction is detected, lowering the frequency by a grid.

Wherein steps b, c, d, e further include an effect in response to sliding a finger, the display window displaying the frequency on the frequency display area may move with the sliding direction of the finger, the display window may jump to the original position when the finger leaves the frequency display area.

Also, another embodiment of the sliding method of the present invention, which is based on the above device, includes the following steps:

a. detecting that the finger touched the touch operation area, and executing corresponding functions according to the touch position;

b. detecting that the finger touched the frequency display area, and generating corresponding station-tuning functions according to the sliding directions of the finger;

c. if a motion in a first direction is detected, searching the last station; if not, entering the next step;

d. if a motion in a second direction is detected, searching the next station; if not, entering the next step;

e. if a motion in a third direction is detected, increasing the frequency by a grid; if not, entering the next step;

f. if a motion in a fourth direction is detected, lowering the frequency by a grid.

Wherein steps c, d, e, f further include an effect in response to sliding a finger, the display window displaying the frequency on the frequency display area may move with the sliding direction of the finger, the display window may jump to the original position when the finger leaves the frequency display area.

### BRIEF DESCRIPTION OF THE INVENTION

The detail structure, the applied principle, the function and the effectiveness of the present invention can be more fully understood with reference to the following description and accompanying drawings, in which:

FIG. 1 is a schematic diagram of a conventional audio operation panel;

FIG. 2 is a schematic diagram of the touch panel according to the present invention;

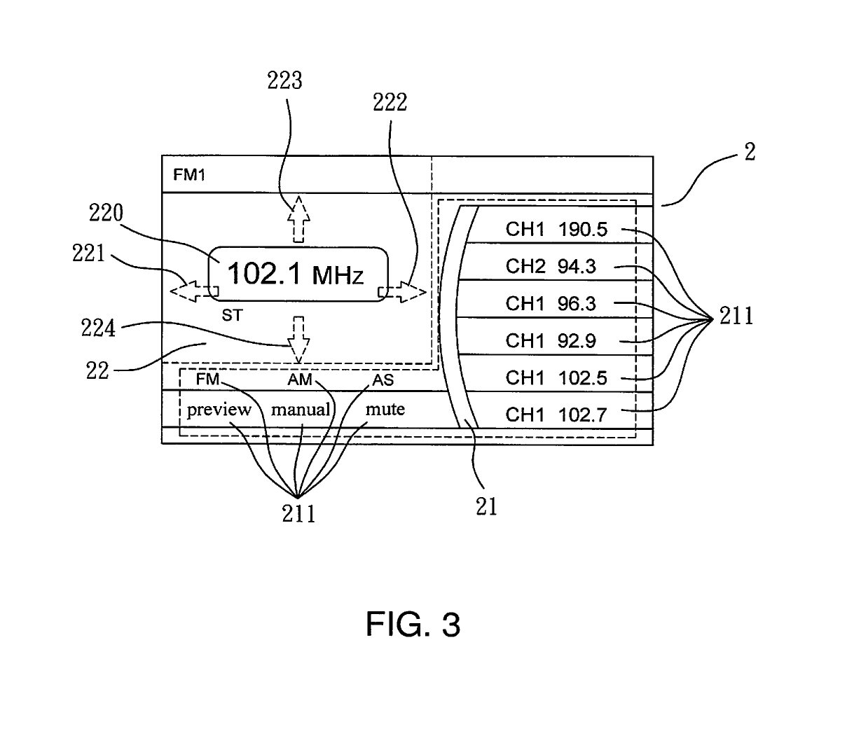

FIG. 3 is a block diagram of the device according to the present invention;

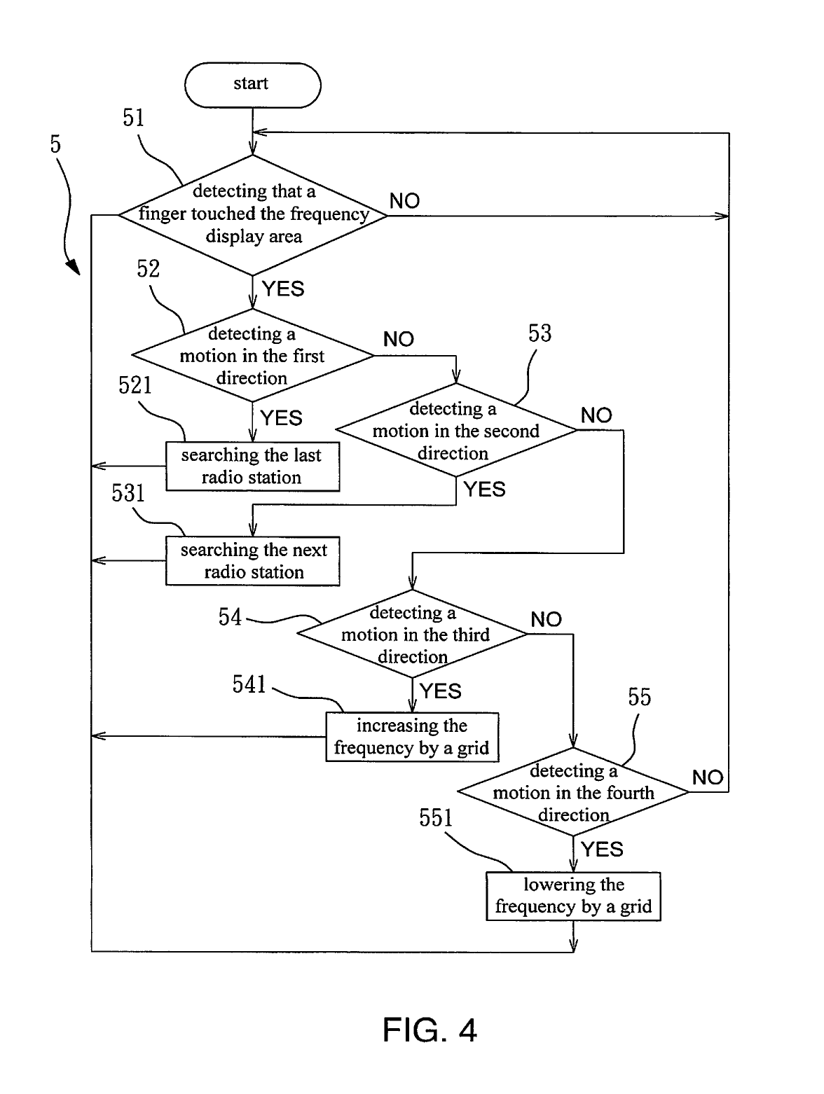

FIG. 4 is a flow chart according to the present invention;

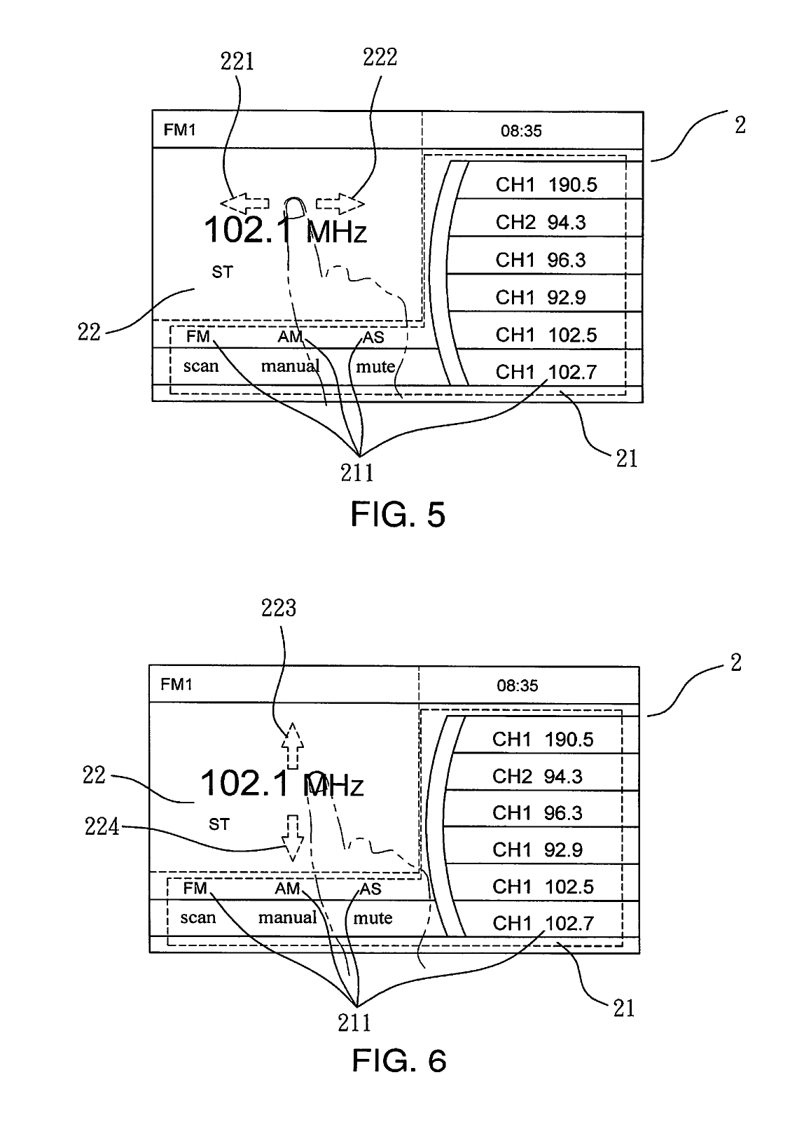

FIG. 5 is a schematic diagram (1) of operation of the present invention;

FIG. 6 is a schematic diagram (2) of operation of the present invention; and

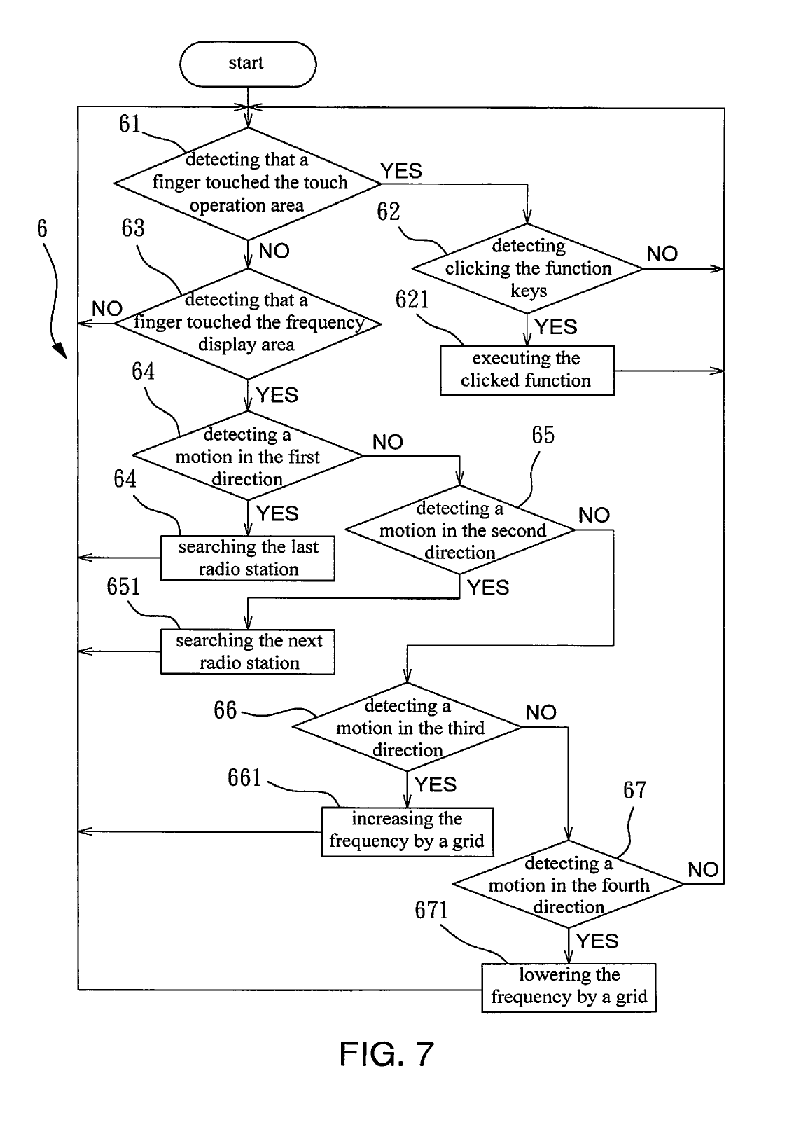

FIG. 7 is a flow chart of another embodiment of the present invention.

### DETAILED DESCRIPTION OF THE PREFFERED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Please refer to FIG. 2 and FIG. 3, the sliding device for tuning radio stations according to the present invention includes a radio module 3, a CPU 4 and a touch panel 2, wherein:

the radio module 3, which receives radio waves (as AM or FM), and decodes the received radio waves into sound signals;

the CPU 4, which is connected to the radio module 3 and the touch panel 2, receives signals from the touch panel 2 to adjust the radio module 3;

the touch panel 2, the screen of the touch panel includes a touch operation area 21 and a frequency display area 22, the touch operation area 21 is a functional area executing corresponding functions according to the touch position, and the frequency display area 22 is a functional area generating corresponding station-tuning functions according to the sliding directions of the finger. The sliding directions of the finger include a first direction 221 (as a leftward direction), a second direction 222 (as a rightward direction), a third direction 223 (as an upward direction) and a fourth direction 224 (as a downward direction).

The above touch operation area 21, wherein multiple function keys 211 are set, the function keys 211 display the frequency of radio stations and the function codes such as AM, FM.

The above frequency display area 22, wherein a display window 220 is set in its central area, and the display window 220 is used to display the frequency of the current received radio station.

By the sliding device for tuning radio stations consisted of the above components, when the user wants to perform the operation of tuning radio stations (as shown in FIG. 5), he touches the frequency display area 22 by the finger. For example, the finger slides in the first direction 221 (the leftward direction), the device may search the last radio station (the adjacent station with lower frequency); the finger slides in the second direction 222 (the rightward direction), the device may search the next radio station (the adjacent station with higher frequency).

When the user wants to fine tune the frequency (as shown in FIG. 6), the finger slides in the third direction 223 (the upward direction), the device may increase the frequency by a grid, such as increasing 0.1 MHz in FM (the width of the grid is set according to use requirements, and may be 0.1 MHz or 0.05 MHz); the finger slides in the fourth direction 224 (the downward direction), the device may lower the frequency by a grid, namely, lowering 0.1 MHz (the width of the grid is set according to use requirements, and may be 0.1 MHz or 0.05 MHz).

Besides, the user may also click the function keys 211 with the set frequency in the touch operation area 21 to listen the desired radio station directly.

Based on the above device, the sliding method for tuning radio stations 5 includes the following steps (please refer to FIG. 4, FIG. 5 and FIG. 6):

a. detecting that the finger touched the frequency display area 22 (step 51), and generating corresponding station-tuning functions according to the sliding directions of the finger;

b. a motion in the first direction 221 is detected (step 52), searching the last station (step 521, as shown in FIG. 5, wherein moving in the first direction 221 means that the finger slides to the left, the tuning function is quickly searching the last station, namely, automatically searching the frequency of a strong radio station by decreasing frequency and then stop searching) and playing; if not, entering the next step;

c. a motion in the second direction 222 is detected (step 53), searching the next station (step 531, as shown in FIG. 5, wherein moving in the second direction 222 means that the finger slides to the right, the tuning function is quickly searching the next station, namely, automatically searching the frequency of a strong radio station by increasing frequency and then stop searching) and playing; if not, entering the next step;

d. a motion in the third direction 223 is detected (step 54), increasing the frequency by a grid (step 541, as shown in FIG. 6, wherein moving in the third direction 223 means that the finger slides up, the tuning function is increasing the frequency by a grid, wherein the width of the grid is set according to use requirements, for example, the width of the grid may be set to increase 0.1 MHz or 0.05 MHz in FM; the width of the grid may be set to increase 9 KHz or 5 KHz in AM); if not, entering the next step;

e. a motion in the fourth direction 224 is detected (step 55), lowering the frequency by a grid (step 551, as shown in FIG. 6, wherein moving in the fourth direction 224 means that the finger slides down, the tuning function is lowering the frequency by a grid, wherein the width of the grid is set according to use requirements, for example, the width of the grid may be set to lower 0.1 MHz or 0.05 MHz in FM; the width of the grid may be set to lower 9 KHz or 5 KHz in AM).

The above sliding method for tuning radio stations 5, wherein the first direction 221 is a leftward direction, the second direction 222 is a rightward direction, the third direction 223 is an upward direction, and the fourth direction 224 is a downward direction.

Wherein steps b, c, d, e further include an effect in response to sliding a finger, the display window 220 displaying the frequency on the frequency display area 22 may move with the sliding direction of the finger, the display window 220 may jump to the original position when the finger leaves the frequency display area 22.

FIG. 7 is a flow chart of another embodiment of the present invention, the method 6 includes the following steps (please refer to FIG. 5, FIG. 6 and FIG. 7):

a. detecting that the finger touched the touch operation area 21 (steps 61, 62), executing corresponding functions according to the touch position (step 621, such as clicking AM, FM or function keys 211 with the set channels to execute the corresponding function);

b. detecting that the finger touched the frequency display area 22 (step 63), and generating corresponding station-tuning functions according to the sliding directions of the finger;

c. a motion in the first direction 221 is detected (step 64), searching the last station (step 641, as shown in FIG. 5, wherein moving in the first direction 221 means that the finger slides to the left, the tuning function is quickly searching the last station, namely, automatically searching the frequency of a strong radio station by decreasing frequency and then stop searching) and playing; if not, entering the next step;

d. a motion in the second direction 222 is detected (step 65), searching the next station (step 651, as shown in FIG. 5, wherein moving in the second direction 222 means that the finger slides to the right, the tuning function is quickly searching the next station, namely, automatically searching the frequency of a strong radio station by increasing frequency and then stop searching) and playing; if not, entering the next step;

e. a motion in the third direction 223 is detected (step 66), increasing the frequency by a grid (step 661, as shown in FIG. 6, wherein moving in the third direction 223 means that the finger slides up, the tuning function is increasing the frequency by a grid, wherein the width of the grid is set according to use requirements, for example, the width of the grid may be set to increase 0.1 MHz or 0.05 MHz in FM; the width of the grid may be set to increase 9 KHz or 5 KHz in AM); if not, entering the next step;
f. a motion in the fourth direction 224 is detected (step 67), lowering the frequency by a grid (step 671, as shown in FIG. 6, wherein moving in the fourth direction 224 means that the finger slides down, the tuning function is lowering the frequency by a grid, wherein the width of the grid is set according to use requirements, for example, the width of the grid may be set to lower 0.1 MHz or 0.05 MHz in FM; the width of the grid may be set to lower 9 KHz or 5 KHz in AM).

The above sliding method for tuning radio stations 6, wherein the first direction 221 is a leftward direction, the second direction 222 is a rightward direction, the third direction 223 is an upward direction, and the fourth direction 224 is a downward direction.

Wherein steps c, d, e, f further include an effect in response to sliding a finger, the display window 220 displaying the frequency on the frequency display area 22 may move with the sliding direction of the finger, the display window 220 may jump to the original position when the finger leaves the frequency display area 22.

Above all, the present invention provides users to slide fingers up and down left and right on the touch panel of the car audio for quickly tuning radio stations and fine tuning frequency, thus, the present invention may solve the drawbacks in the prior art and has novelty, practicality and progressive benefits.

I claim:

1. A sliding device for tuning radio stations, which includes a radio module, a CPU and a touch panel, wherein:
the radio module, which receives radio waves, and decodes the received radio waves into sound signals;
the CPU, which is connected to the radio module and the touch panel, receives signals from the touch panel to adjust the radio module;
the touch panel, the screen of the touch panel includes a touch operation area and a frequency display area, the touch operation area is a functional area executing corresponding functions according to the touch position, and the frequency display area is a functional area generating corresponding station-tuning functions according to the sliding directions of the finger.

2. The sliding device for tuning radio stations as claimed in claim 1, wherein the frequency display area displays the frequency of the current received radio station.

3. The sliding device for tuning radio stations as claimed in claim 1, wherein multiple function keys are set in the touch operation area, and the function keys display the frequency of radio stations and the function codes.

4. A sliding method for tuning radio stations, the screen of a touch panel includes a frequency display area, the frequency display area generates corresponding station-tuning functions according to the sliding directions of the finger, the methods includes the following steps:
a. detecting that the finger touched the frequency display area, and generating corresponding station-tuning functions according to the sliding directions of the finger;
b. if a motion in a first direction is detected, searching the last station; if not, entering the next step;
c. if a motion in a second direction is detected, searching the next station; if not, entering the next step;
d. if a motion in a third direction is detected, increasing the frequency by a grid; if not, entering the next step;
e. if a motion in a fourth direction is detected, lowering the frequency by a grid.

5. The sliding method for tuning radio stations as claimed in claim 4, wherein the first direction is a leftward direction, the second direction is a rightward direction, the third direction is an upward direction, and a fourth direction is a downward direction.

6. The sliding method for tuning radio stations as claimed in claim 4, wherein the width of the grid used for increasing or lowering the frequency is set according to use requirements.

7. The sliding method for tuning radio stations as claimed in claim 4, wherein steps b, c, d, e further include an effect in response to sliding a finger, the display window displaying the frequency on the frequency display area may move with the sliding direction of the finger, the display window may jump to the original position when the finger leaves the frequency display area.

8. A sliding method for tuning radio stations, the screen of a touch panel includes a touch operation area and a frequency display area, the touch operation area executes corresponding functions according to the touch position, the frequency display area generates corresponding station-tuning functions according to the sliding directions of the finger, the methods includes the following steps:
a. detecting that the finger touched the touch operation area, and executing corresponding functions according to the touch position;
b. detecting that the finger touched the frequency display area, and generating corresponding station-tuning functions according to the sliding directions of the finger;
c. if a motion in a first direction is detected, searching the last station; if not, entering the next step;
d. if a motion in a second direction is detected, searching the next station; if not, entering the next step;
e. if a motion in a third direction is detected, increasing the frequency by a grid; if not, entering the next step;
f. if a motion in a fourth direction is detected, lowering the frequency by a grid.

9. The sliding method for tuning radio stations as claimed in claim 8, wherein the first direction is a leftward direction, the second direction is a rightward direction, the third direction is an upward direction, and a fourth direction is a downward direction.

10. The sliding method for tuning radio stations as claimed in claim 8, wherein multiple function keys are set in the touch operation area, and the function keys display the frequency of radio stations and the function codes.

11. The sliding method for tuning radio stations as claimed in claim 8, wherein the width of the grid used for increasing or lowering the frequency is set according to use requirements.

12. The sliding method for tuning radio stations as claimed in claim 8, wherein steps c, d, e, f further include an effect in response to sliding a finger, the display window displaying the frequency on the frequency display area may move with the sliding direction of the finger, the display window may jump to the original position when the finger leaves the frequency display area.
